(19) United States
(12) Patent Application Publication
(10) Pub. No.: US 2013/0175793 A1
(43) Pub. Date: Jul. 11, 2013

(54) IDENTITY DOCUMENT WITH SECURE IMAGE

(71) Applicant: Lasercard Corporation, Mountain View, CA (US)

(72) Inventor: Frantz Mercier, Hollister, CA (US)

(73) Assignee: LASERCARD CORPORATION, Mountain View, CA (US)

(21) Appl. No.: 13/735,249

(22) Filed: Jan. 7, 2013

(30) Foreign Application Priority Data
Jan. 9, 2012 (CH) 00028/12

(51) Int. Cl. B42D 15/00

(52) U.S. Cl. CPC B42D 15/00
USPC 283/74

(57) ABSTRACT

An identification document and method of manufacturing the same is disclosed. Specifically, the identification document includes an image area in which both a base material of the identification document and a security material are present. One or more images are written into the image area such that reliefs are created in both the base material and the security material and also such that the image is a continuous image, even across transitions from the base material and the security material.

### FIELD OF THE DISCLOSURE

The present disclosure is generally directed toward identity documents and specifically directed toward securing identity documents.

### BACKGROUND

The use of identification documents and other credentials is pervasive. Identification documents are used on a daily basis for a number of different purposes. Identification documents are most commonly used to prove identity, to verify age, to access an asset (e.g., secure area, financial account, computing resource, etc.), to evidence driving privileges, to cash a check, and so on. Airplane passengers are required to show a identify documents during check in, and sometimes at security screening and prior to boarding their flight. We also live in an ever-evolving cashless society where identity documents are used to make payments, access an automated teller machine (ATM), debit an account, or make a payment, etc. Many industries require that their employees carry photo identification documents on the job and to access various locations on a job site.

While many different types of security features have been developed to enhance the security associated with identity documents, few have been as useful and difficult to copy as holographic features. Most holographic security features are attached to the document base during the manufacturing process. If the document is in part an optical recording medium, then it is possible to record the hologram directly into the medium. A practical implementation of this concept presents a large number of technical and price hurdles especially if the medium is not tailored for holographic recording. A complex optical system is required to record a quality hologram. The plastics industry is working with companies specializing in holography to develop an optical medium suitable for both holographic data storage and personalized holograms visible in natural light.

For security holograms, the optical recording requirement can be eliminated by creating a computer generated hologram on the master of formatted medium information (the photo mask). This becomes practical if the lithographic process has sub-micron resolution and the formatted medium has good diffraction characteristics (a contoured surface). The resulting security hologram is more secure than the attached holograms currently employed on bank cards. In the latter case, a counterfeited label can be attached to a bank card. To counterfeit a hologram which is a part of the credential optical medium format, on the other hand, the whole medium must be counterfeited.

### SUMMARY

It is, therefore, one aspect of the present disclosure to provide a secure identification document and particularly one with one or more secure images.

Even more specifically, an identification document is described that includes one or more image areas that have been secured with an additional security material. In some embodiments, an additional security material may correspond to a pre-fabricated reflective and/or holographic material. In some embodiments, the additional security material is both reflective and holographic.

The security material may be applied to one or more portions of an image area on the identification document to facilitate the creation of a unique secure image instead of a security add-on to an existing image. In this way, the identification document can be provided with a multi-layer seamless photo.

The number of additional security materials that are applied to the image area may vary from a single layer of an additional security material to multiple layers of additional security materials. As one example, an image area may comprise a first layer of material corresponding to a base layer of the identification document, a second layer of material corresponding to a first additional security material, and a third layer of material corresponding to a second additional security material. The first additional security material may comprise the pre-fabricated reflective and/or holographic material whereas the second additional security material may comprise a clear polymer-based material. An image may then be written onto each of the first, second, and third layers of material, thereby creating an identification document that has an image with multiple security layers.

It is another aspect of the present disclosure to provide a method for constructing an identification document as described herein. In particular, the method begins by applying one or more additional security materials to a first material of a substrate, which corresponds to a base layer of the identification document. The method continues by writing one or more images into the identification document such that the image is continuously and seamlessly written into both the first material and the additional security material(s). This way, a single and continuous image is integrated into the multiple layers of the identification document, including the additional security material. As discussed above, if the identification document comprises more than one additional security material, then the image may be written into each of the additional security materials as well as the first material of the substrate.

In some embodiments, an engraver, such as a laser engraver, is used to write the image(s) into the identification document. Depending upon which material is currently being written to, the settings of the laser engraver may be adjusted to accommodate the material differences of the material currently being written to.

For the purposes of this disclosure, identification documents are broadly defined and may include, for example, credit cards, bank cards, phone cards, passports, driver's licenses, network access cards, employee badges, debit cards, security cards, visas, immigration documentation, national ID cards, citizenship cards, social security cards, security badges, certificates, identification cards, voter registration cards, police ID cards, border crossing cards, legal instruments or documentation, security clearance badges and cards, gun permits, gift certificates or cards, labels or product packaging, membership cards or badges, etc. Also, the terms “document,” “credential,” “card,” and “documentation” are used interchangeably throughout this application. Identification documents may sometimes be interchangeably referred to as “security documents,” “ID documents,” “credential documents,” “security credentials,” “photo-IDs,” and “photo ID documents”.

The present invention will be further understood from the drawings and the following detailed description. Although this description sets forth specific details, it is understood that certain embodiments of the invention may be practiced without these specific details. It is also understood that in some instances, well-known circuits, components and techniques have not been shown in detail in order to avoid obscuring the understanding of the invention.

### BRIEF DESCRIPTION OF THE DRAWINGS

The present disclosure is described in conjunction with the appended figures:

FIG. 1 is a top view of an identification document in accordance with embodiments of the present disclosure;

FIG. 2A is a top view of a first intermediate product in accordance with embodiments of the present disclosure;

FIG. 2B is a cross-sectional view across line 2-2 depicted in FIG. 2A;

FIG. 3A is a top view of a second intermediate product in accordance with embodiments of the present disclosure;

FIG. 3B is a cross-sectional view across line 3-3 depicted in FIG. 3A;

FIG. 4A is a top view of a third intermediate product in accordance with embodiments of the present disclosure;

FIG. 4B is a cross-sectional view across line 4-4 depicted in FIG. 4A;

FIG. 5A is a top view of an identification document in accordance with embodiments of the present disclosure;

FIG. 5B is a cross-sectional view across line 5-5 depicted in FIG. 5A; and

FIG. 6 is a flow diagram depicting a method of constructing an identification document in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

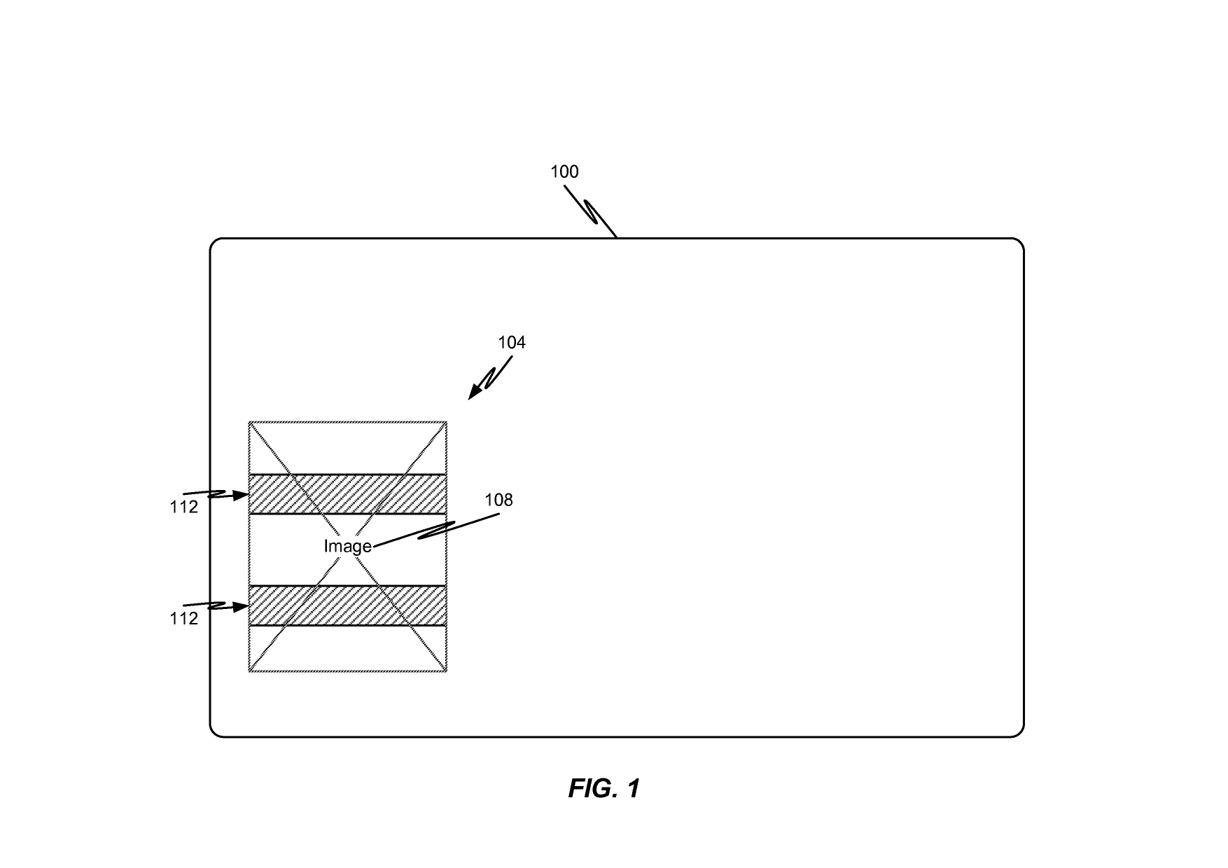

Referring initially to FIG. 1, an identification document 100 comprising enhanced security features will be described in accordance with embodiments of the present disclosure. The identification document 100 includes one or more image areas 104. The image area 104 may correspond to a predetermined location or set of locations on a surface of the identification document 100 that is designated to receive one or more images 108. Specifically, the image area 104 may include a region of a predetermined size that can have an image or multiple images written therein. As a non-limiting example, the intended holder of the identification document 100 may have their picture written into the image area 104 as the image 108. Any other type of picture or non-picture object (e.g., character, symbol, letter, word, number, etc.) can also be incorporated into the image 108.

As can be seen, the image area 104 comprises one or more layers of security material 112. The security material 112 can be incorporated into the entirety of the identification document 100 or it can be applied to a portion of the identification document 100, such as the portion corresponding to the image area 104. In some embodiments, the security material 112 is pre-fabricated (e.g., manufactured separately from the identification document 100) and then applied to the identification document 100. The security material 112, when pre-fabricated, can be welded, glued, stamped, laminated, pressed, or otherwise secured to the base material of the identification document 100.

The security material 112 may be constructed by using any known type of process for creating holograms and/or reflective materials. As one non-limiting example, the security material 112 is pre-fabricated as is described in PCT Publication No. WO/2011/133352 to LaserCard Corporation, the entire contents of which are hereby incorporated herein by reference. The security material 112 may alternatively, or additionally, be constructed according to the process described in U.S. Pat. No. 7,101,644 to Toshine et al., the entire contents of which are hereby incorporated herein by reference.

In some embodiments, the image 108 is written into the image area 104 only after the security material 112 has been applied to the image area 104. In this way, the image 108 is continuously and seamlessly integrated into both the base material of the identification document 100 as well as the security material 112. This makes the process of counterfeiting the identification document 100 more expensive and time-consuming.

Although FIG. 1 depicts the image area 104 as being the only area on the identification document 100 that includes the security material 112, the invention is not so limited. For example, it is contemplated that the security material 112 can be incorporated into other portions of the identification document 100. Further still, the security material 112 can occupy any fraction of the image area 104. In particular, the percentage of security material 112 in the image area 104 as compared to the base material of the identification document 100 can vary anywhere between about 1% and about 100%. As a few more non-limiting examples, the percentage of security material 112 in the image area 104 can be between about 25% and 50% and even more specifically about 33%.

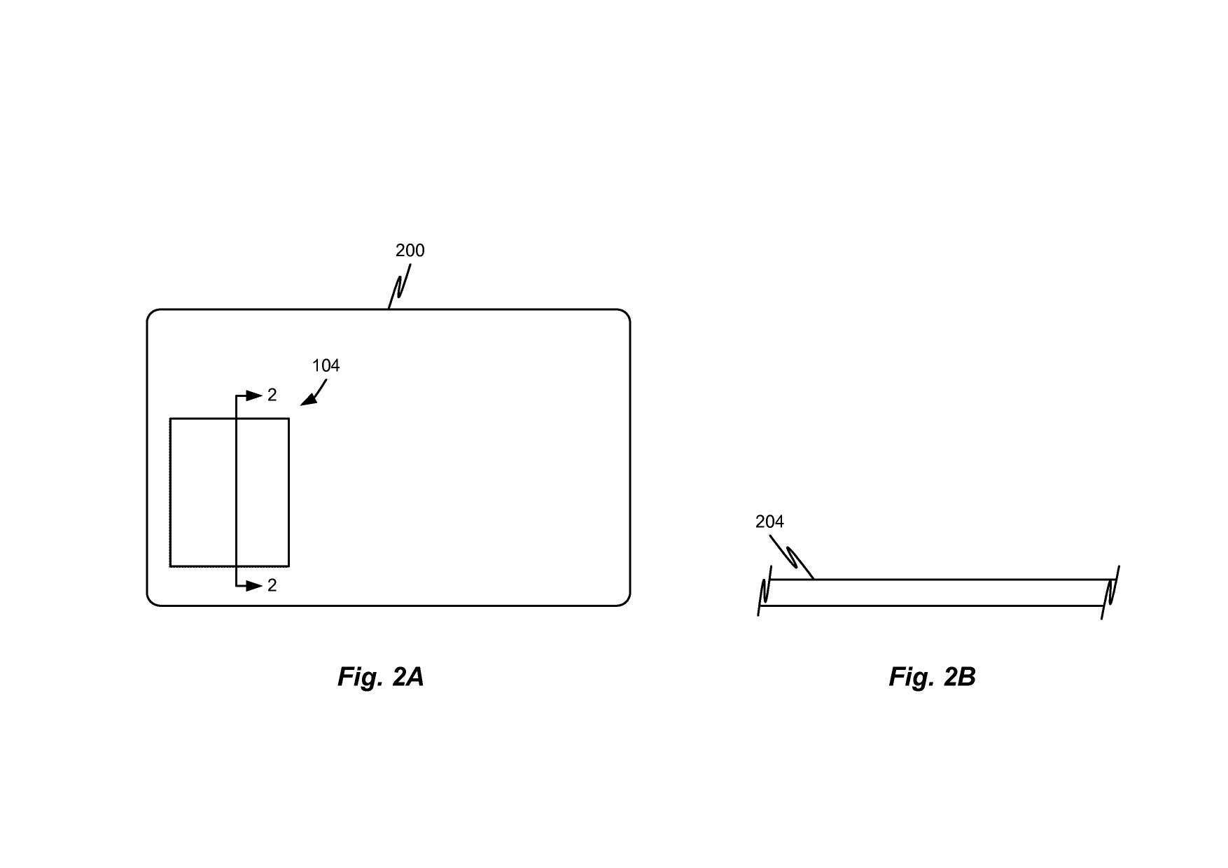

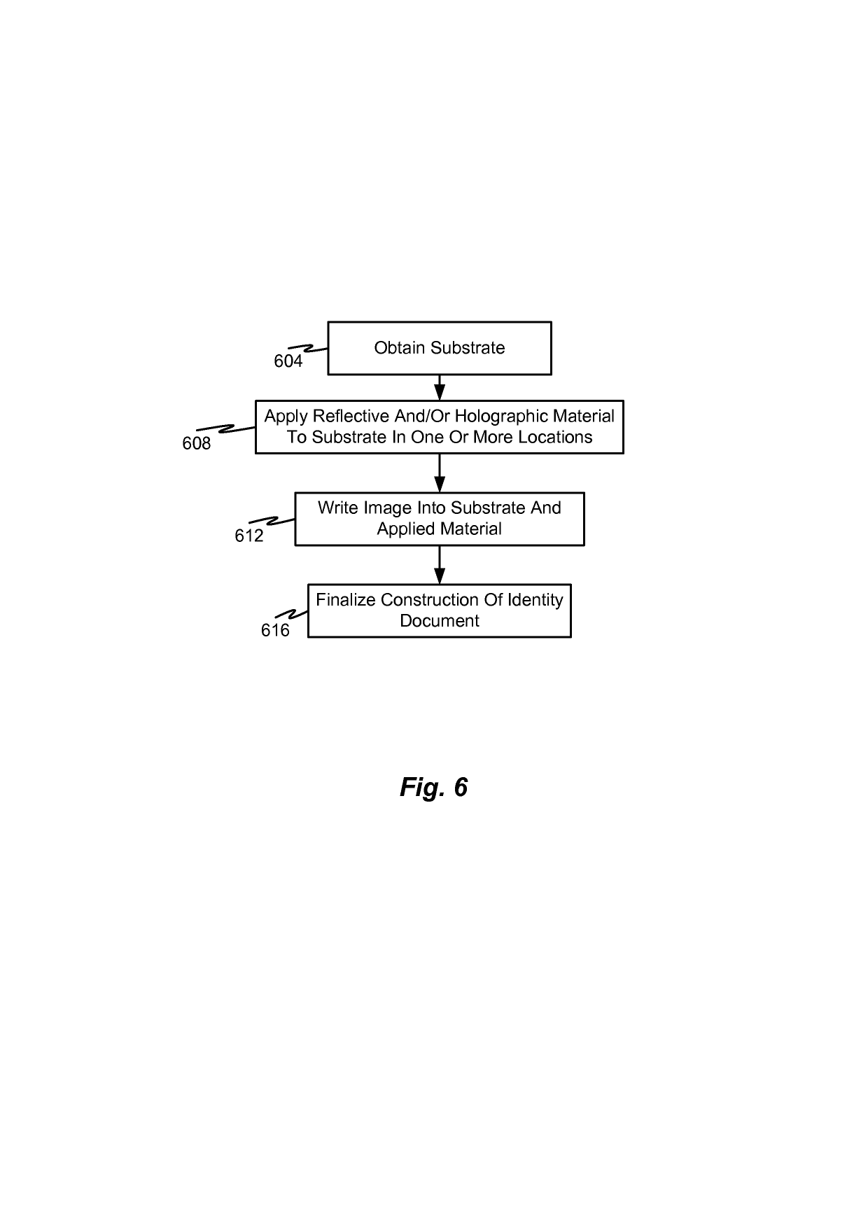

With reference now to FIGS. 2A-6, an example of the process for constructing the identification document 100 will be described in accordance with at least some embodiments of the present disclosure. FIGS. 2A and 2B depict a first step in the process (step 604) where a first intermediate product 200 is obtained. Specifically, the first intermediate product 200 corresponds to an identification document that has yet to be treated with a security material 112. In particular, the first intermediate product 200 may comprise a substrate 204 constructed with a base material or collection of base materials used to manufacture identification documents in a conventional manner. Examples of non-limiting materials that may be included in the substrate 204 include polycarbonate (PC), polyvinyl chloride (PVC), polyethylene terephtalate (PET), composites of PC/PVC/PET in any ratio, adhesives consisting of an acrylic or methacrylic resin, ethylene/vinyl acetate copolymers, water dispersible co-polyesters containing free acid groups, or heat sealable coating polymers, or any combination thereof. Furthermore, the materials included in the substrate 204 may comprise any color or combinations of colors such as black, white, yellow, etc.

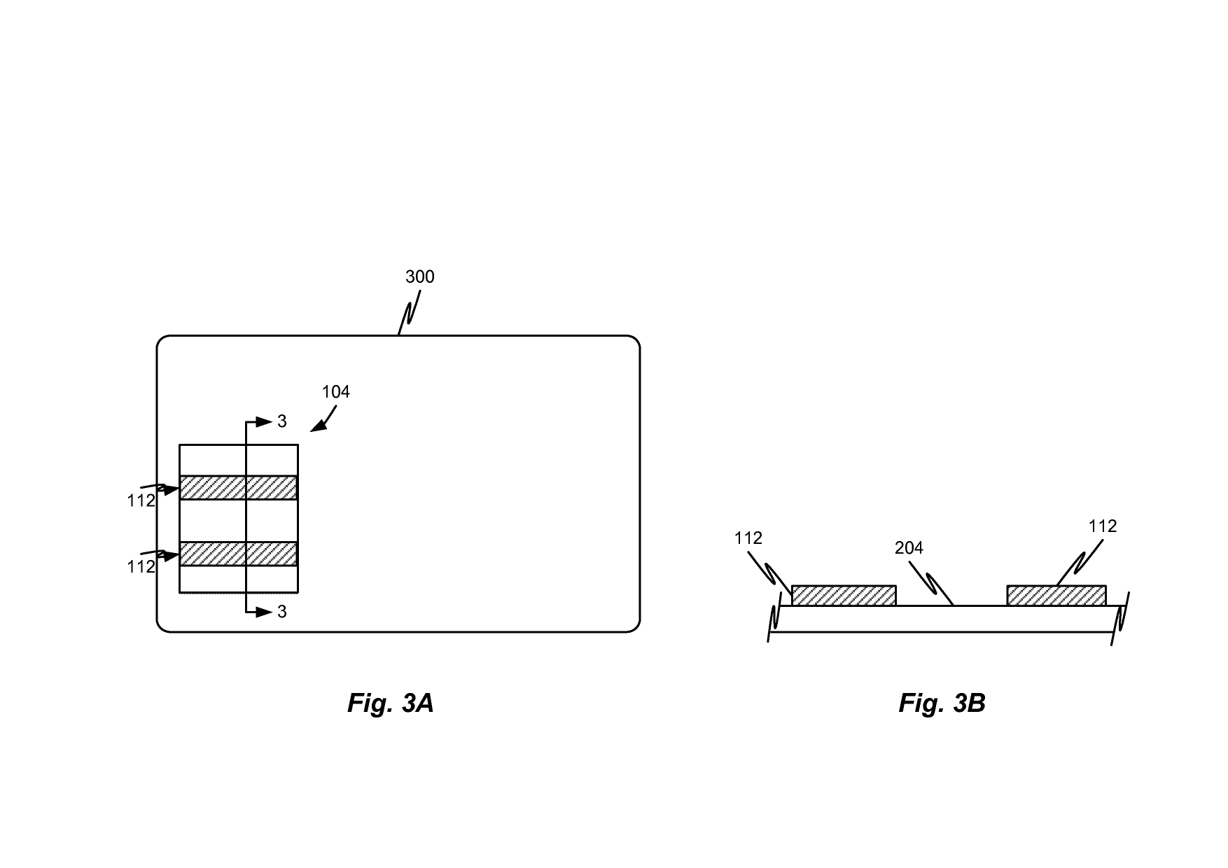

FIGS. 3A and 3B depict a second step in the process (step 608) where a second intermediate product 300 is obtained. Specifically, the second intermediate product 300 corresponds to the first intermediate product 200 that has one or more layers of security material 112 fixed, secured, or otherwise applied to a top major surface of the substrate 204. In some embodiments, the security material 112 is only applied to the image area 104 of the second intermediate product 300. Application of the security material 112 creates a first portion of the image area 104 having an exposed substrate 104 and a second portion of the image area 104 having an exposed security material 112. In some embodiments, the security material 112 may be applied to the substrate 204 to create a patchwork of multiple first and second portions (e.g., areas having different exposed materials at the top surface of the identification document) and the image 108 will ultimately extends in a continuous manner over multiple transition zones from one portion to another portion (e.g., from one material type to another material type).

Although the embodiment depicted in FIGS. 3A and 3B only show a single type of security material 112 being applied to the substrate 204, it should be appreciate that any number of different types of security materials can be applied to the substrate 204 directly or by stacking multiple security materials on top of one another.

In some embodiments, the security material 112 comprises a reflective holographic material. In some embodiments, the security material 112 is only reflective. In some embodiments, the security material is only holographic. In some embodiments, a clear layer of plastic is applied over the top of the reflective and/or holographic security material 112 as well as the other exposed portions of the substrate 204, thereby creating multiple material layers in the image area 104.

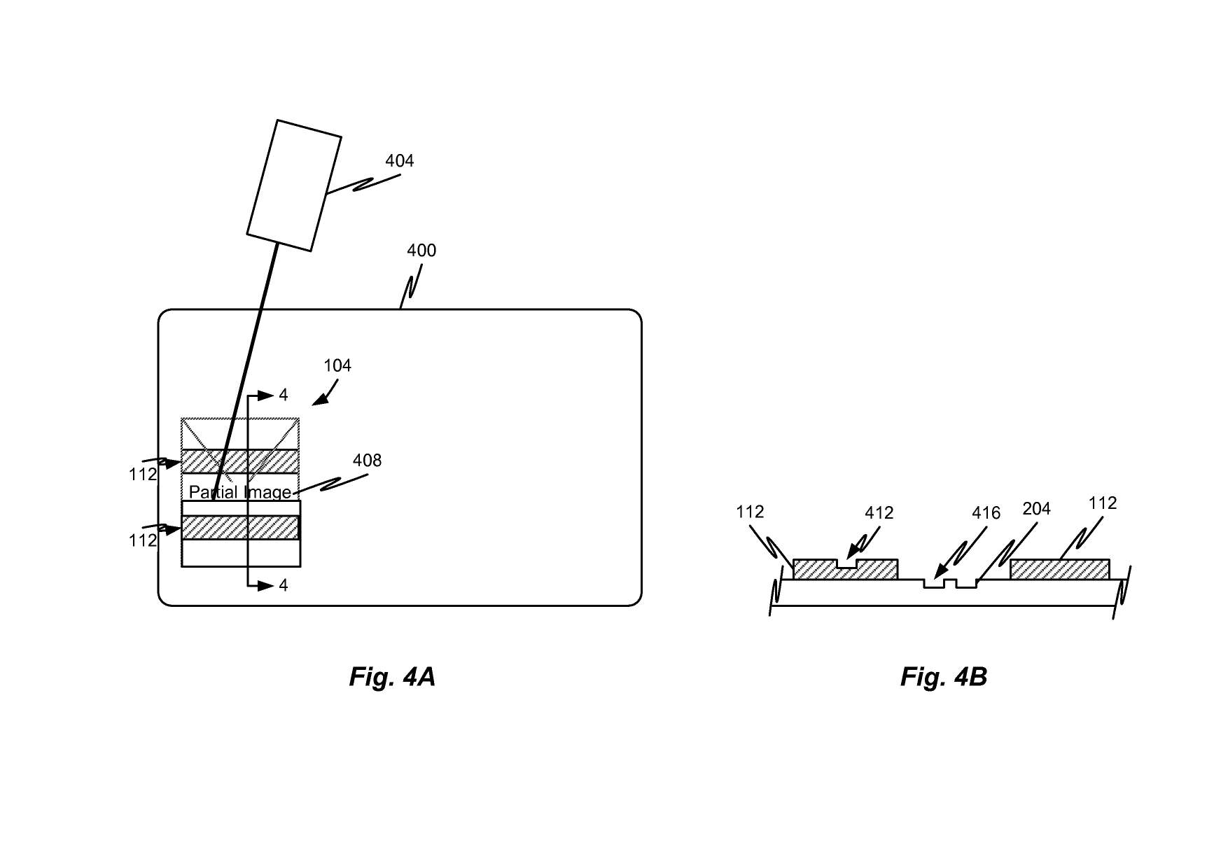

FIGS. 4A and 4B depict a third step in the process (step 612) where a third intermediate product 400 is obtained. In particular, the third intermediate product 400 corresponds to the second intermediate product 300 that comprises a partially-written image 408. A writing apparatus 404, such as a laser engraver, may be used to create etches or reliefs 412, 416 in the third intermediate product 400 that eventually become the image 108. In accordance with at least some embodiments of the present disclosure, the writing apparatus 404 is used to remove a predetermined amount of material from the security material 112 and the substrate 204 in the image area 104. As the material is removed, the partial image 408 continues to extend across the image area 104 until the complete image 108 is created.

Removal of the security material 112 may result in the creation of a first set of reliefs 412 whereas remove of the substrate 204 may result in the creation of a second set of reliefs 416. The first and second set of reliefs 412, 416 may collectively create the structure of the image 108. In some embodiments, the first set of reliefs 412 may be configured to have a depth that is less than the thickness of the security material 112. In some embodiments, the first set of reliefs 412 may be configured to have a depth that is greater than the thickness of the security material 112, thereby resulting in reliefs that span both the security material 112 and the substrate 204.

Likewise, the second set of reliefs 416 may be configured to have a depth of a predetermined amount. The depth of the reliefs 412, 416 may be varied and/or controlled by the settings of the writing apparatus 404. Moreover, since the security material 112 is different from the material of the substrate 204, it may be necessary to operate the writing apparatus 404 at different operating parameters depending upon whether the image is currently being written into the security material 112 or the substrate 204. In other words, although the image may be continuously written, the settings of the writing apparatus 404 may be dynamically varied during the writing process to adjust to the properties of the security material 112 and substrate 204.

As a non-limiting example, the writing apparatus 404 may comprise a laser engraver that employs a laser beam to engrave, depress, or otherwise remove material while writing the image. In some embodiments, the settings of such a laser engraver may be varied to create reliefs 412, 416 that have dimensions on that are roughly one or more microns deep by one or more microns wide. Furthermore, the dimensions of the first set of reliefs 412 do not necessarily have to be equal to the dimensions of the second set of reliefs 416. Further still, the laser engraver may be configured such that, in the image area 104, the frontier lines between first and second portions (e.g., a first portion comprising the exposed substrate 204 and a second portion comprising the exposed security material 112) are always parallel to the laser engraving processing line (e.g., the resulting line that creates the image) such that laser engraver does not adjust its operating parameters in middle of a processing line. This results in a continuous image, even across disparate materials in the image area 104.

Although not depicted, if an additional clear layer is placed over the image area 104 prior to writing the image, reliefs may be created in the additional clear layer. As discussed above, if such an additional material is incorporated into the identification document, then the operating parameters of the writing apparatus 404 may need to be adjusted accordingly.

As can be appreciated by those of skill in the art, the writing apparatus 404 may employ any number of technologies suitable for creating the reliefs 412, 416. Examples of such technologies include, without limitation, optical-based technologies (e.g., laser engraver), chemical-based technologies (e.g., masking used in combination with chemical material removal technologies), and/or mechanical-based technologies (e.g., saw, drill, roller, press, stamp, etc.). It should be appreciated that any technology that can be used to create the relief structures 412, 416 may be employed without departing from the scope of the present disclosure.

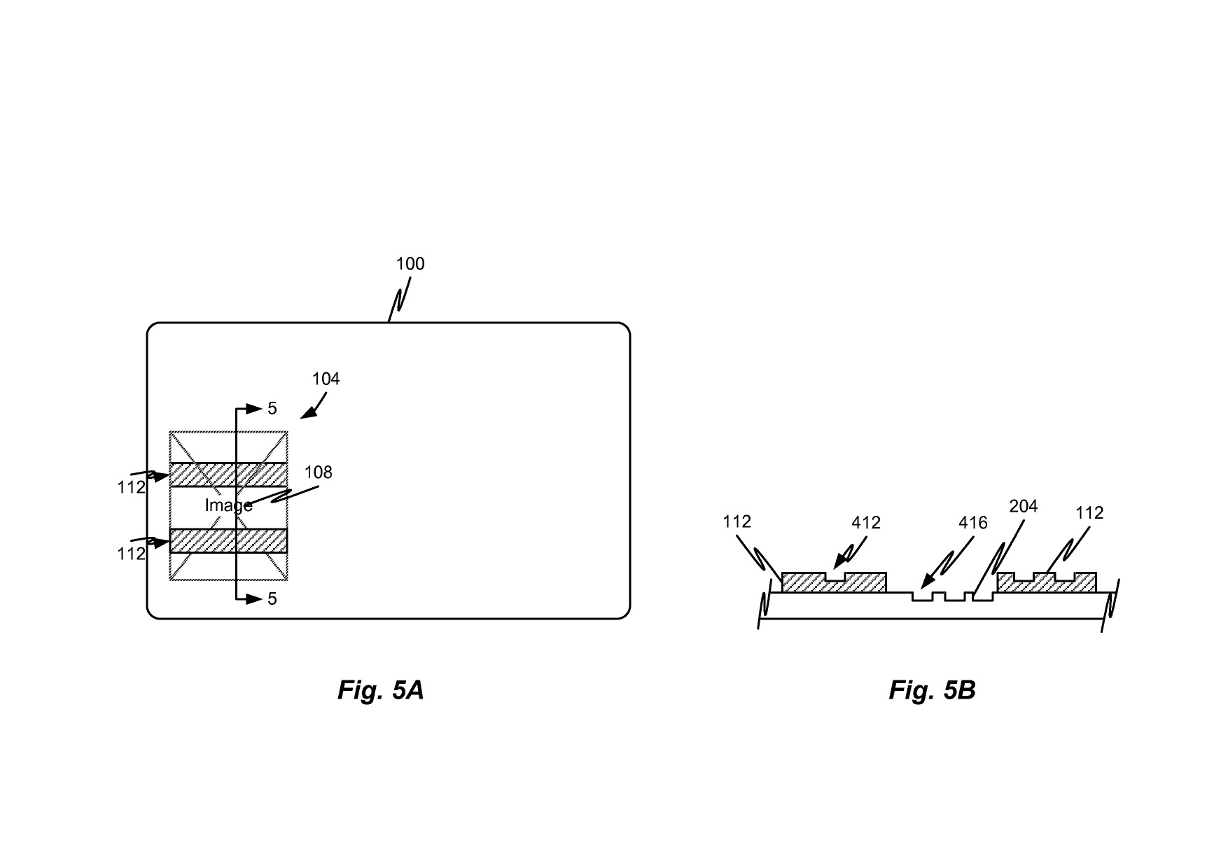

FIGS. 5A and 5B show the completed identification document 100 where the image 108 is completely written into the image area 104. In other words, the identification document 100 now has the full image written 108 by virtue of the fact that the writing apparatus 404 has created the first and second reliefs 412, 416 in the image area 104. The manufacturing process may be completed by performing any additional steps necessary to finalize the identification document 100 (step 616). In particular, the identification document 100 may have additional protective layers applied thereto after the image 108 has been written.

In the foregoing description, for the purposes of illustration, methods were described in a particular order. It should be appreciated that in alternate embodiments, the methods and steps thereof may be performed in a different order than that described.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. An identification document, comprising:
a substrate comprising an image area wherein at least one first portion of the surface of the image area is made of a first material;
at least one patch of a security material covering at least one second portion of said image area, the security material having reflective or holographic properties which are different of the ones of the first material; and
a laser engraved security image extending at least over at least each of one said first and second portions in a continuous manner.

2. The identification document of claim 1, wherein the entire surface of the image area is made of the first material on portions of which the at least one patch of security material is applied.

3. The identification document of claim 1, wherein the security image comprises at least one of an identity picture, character, symbol, letter, word, and number.

4. The identification document of claim 1, wherein the image area consists essentially of a patchwork of multiple of first and second portions and wherein the security image extends in a continuous manner over multiple transition zones from one portion type to the other portion type.

5. The identification document of claim 4, wherein the patches of security material are bands extending in parallel manner through the image area.

6. The identification document of claim 1, wherein the first material comprises at least one of polycarbonate, polyvinyl chloride, and polyethylene terephtalate.

7. The identification document of claim 1, further comprising an additional clear layer of material positioned over the first material and the security material.

8. The identification document of claim 1, wherein the patch of security material is at least one of welded, glued, stamped, laminated, pressed, and secured on the first image area.

9. A method of manufacturing an identification document, comprising:
providing a substrate comprising an image area wherein at least one first portion of the surface of the image area is made of a first material;
positioning a security material covering at least one second portion of said image area, the security material comprising at least one of reflective and holographic properties which are different of the ones of the first material; and
laser engraving a security image such that the image extends on a continuous manner over at least each of one said first and second portions.

10. The method of claim 9, further comprising:
adjusting at least one operating parameter of the laser engraver depending upon whether the image is being engraved into the first material or whether the image is being engraved into the security material.

11. The method of claim 9, such that, in the image area, the frontier lines between first and second portions are always parallel to the laser engraving processing line such that laser engraver does not adjust its operating parameters in middle of a processing line.
